(19) United States
(12) Patent Application Publication
(10) Pub. No.: US 2018/0181892 A1
(43) Pub. Date: Jun. 28, 2018

(54) SYSTEM FOR FORECASTING CORE RETURN FOR REMANUFACTURING

(71) Applicant: Caterpillar Inc., Peoria, IL (US)

(72) Inventor: Waylon WALKER, Peoria, IL (US)

(73) Assignee: Caterpillar Inc., Peoria, IL (US)

(21) Appl. No.: 15/389,621

(22) Filed: Dec. 23, 2016

(51) Int. Cl. G06Q 10/06

(52) U.S. Cl. CPC G06Q 10/06313; G06Q 10/0637; G06Q 10/06311

(57) ABSTRACT

A system for forecasting core return for remanufacturing includes a CPU for executing machine instructions and a memory for storing machine instructions to be executed by the CPU, the machine instructions implementing various operations when executed by the CPU. The operations include receiving at the CPU historical machine data including warranty claims for units of a particular core machine part or assembly, determining from the historical machine data at least one of specific service and failure intervals for the units, determining an actual percent runtime of the units in the field, and forecasting a length of time until a sufficient number of the units of the particular core machine part or assembly needing remanufacturing will be returned to meet a minimum threshold quantity of core for remanufacturing. The operations also include outputting action items to relevant business units based on the forecasted length of time having elapsed to at least one of acquire capital for a remanufacturing operation, set up a remanufacturing line, and assign human resources for the remanufacturing line.

### TECHNICAL FIELD

The present disclosure is directed to a system for forecasting core return and, more particularly, to a system for forecasting core return for remanufacturing.

### BACKGROUND

Remanufactured part programs rely on the cheap availability of quality used parts, otherwise referred to as cores, to be remanufactured. Brokers, original equipment suppliers, dealers, and junkyards collect cores in various industries. Various business initiatives such as continuous product improvement (CPI) and new product introduction (NPI) can implement design changes to various parts and assemblies of parts that result in original core parts and assemblies becoming obsolete. This may happen as a result of a design change that requires the addition of material to an original core part in order to bring the core part into conformance with current standards. In cases where addition of material to the original core, such as through additive manufacturing processes, is not a viable option, the original core parts may be classified as bad core, and may no longer have any use other than as scrap. Variations in the actual use of the core parts and assemblies in the field, in addition to potential design changes resulting in bad core contribute to difficulty in forecasting when sufficient good core will be returned to meet a minimum threshold quantity of core. The minimum threshold quantity of core may be predetermined to meet a business justification for setting up a remanufacturing operation for returned core.

A system and method that addresses core availability and quality issues, and enables the forecasting of when sufficient good core will be returned to meet a predetermined minimum threshold would facilitate the achievement of many business objectives. Business objectives include keeping resources used throughout the manufacturing process within the business's value chain through a circular flow of materials, energy, and water, in addition to efficiently managing human resources. A focus on better systems for managing core could optimize the use of resources, maximize the total life cycle value of products, and minimize the cost of ownership of the products by customers. An effective core management program would contribute to a business objective of making sustainable progress for communities, the environment, and the economy. Remanufacturing and rebuild programs increase the lifespan of equipment by providing customers with product updates for a fraction of the cost of buying a new machine. Additional benefits to the customer include ensuring maximum productivity, increasing reliability and equipment runtime, ensuring cost-effective performance, receiving a like-new warranty, increasing customer return on investment, providing the customer with a variety of repair options, providing the customer with higher resale value, and preserving the majority of energy and materials required to make the original parts or assemblies of parts.

The present disclosure is directed to overcoming one or more of the problems set forth above.

### SUMMARY

In one aspect, the present disclosure is directed to a system for forecasting core return for remanufacturing. The system includes a central processing unit (CPU) for executing machine instructions and a memory for storing machine instructions to be executed by the CPU. The machine instructions cause the CPU to perform various operations including receiving at the CPU historical machine data including warranty claims for units of a particular core machine part or assembly. The stored machine instructions also cause the CPU to determine from the historical machine data at least one of specific service and failure intervals for the units of the particular core machine part or assembly, and determine an actual percent runtime of the units of the particular core machine part or assembly in the field, wherein the actual percent runtime is based on actual working hours for each unit of the particular core machine part or assembly divided by total hours in service for each unit from release to the most recent repair date. The stored machine instructions also cause the CPU to forecast a length of time until a sufficient number of the units of the particular core machine part or assembly needing remanufacturing will be returned to a business manufacturing facility to meet a minimum threshold quantity of core predetermined to meet a business justification for setting up a remanufacturing operation for returned core, and output one or more action items to one or more relevant business units based on the forecasted length of time having elapsed to at least one of acquire capital for a remanufacturing operation, set up a remanufacturing line, and assign human resources for the remanufacturing line.

In another aspect, the present disclosure is directed to a method for forecasting core return for remanufacturing. The method includes receiving, at a CPU, historical machine data including warranty claims for units of a particular core machine part or assembly, determining, using the CPU, at least one of specific service and failure intervals for the units of the particular core machine part or assembly, and determining, using the CPU, an actual percent runtime of the units of the particular core machine part or assembly in the field, wherein the actual percent runtime is based on actual working hours for each unit of the particular core machine part or assembly divided by total hours in service for each unit from release to the most recent repair date. The method also includes forecasting, using the CPU, a length of time until a sufficient number of the units of the particular core machine part or assembly needing remanufacturing will be returned to meet a minimum threshold quantity of core predetermined to meet a business justification for setting up a remanufacturing operation for returned core, and outputting one or more action items to one or more relevant business units based on the forecasted length of time having elapsed to at least one of acquire capital for a remanufacturing operation, set up a remanufacturing line, and assign human resources for the remanufacturing line.

In another aspect, the present disclosure is directed to a computer-readable medium having stored thereon machine instructions to be executed by a CPU, the machine instructions implementing operations for forecasting core return for remanufacturing when executed by the CPU. The operations include receiving, at the CPU, historical machine data including warranty claims for units of a particular core machine part or assembly, determining, using the CPU, at least one of specific service and failure intervals for the units of the particular core machine part or assembly, and determining, using the CPU, an actual percent runtime of the units of the particular core machine part or assembly in the field, wherein the actual percent runtime is based on actual working hours for each unit of the particular core machine part or assembly divided by total hours in service for each unit from release to the most recent repair date. The operations also include forecasting, using the CPU, a length of time until a sufficient number of the units of the particular core machine part or assembly needing remanufacturing will be returned to a business remanufacturing facility to meet a minimum threshold quantity of core predetermined to meet a business justification for setting up a remanufacturing operation for returned core, and outputting, from the CPU, one or more action items to one or more relevant business units based on the forecasted length of time having elapsed to at least one of acquire capital for a remanufacturing operation, set up a remanufacturing line, and assign human resources for the remanufacturing line.

### BRIEF DESCRIPTION OF THE DRAWING

FIG. 1 is a graph showing various plots of the release of good and bad core of machine parts and assemblies over time and the forecasted return of a mix of the good and bad core.

FIG. 2 illustrates a histogram plot of the quantities of parts/assemblies vs. percent runtimes.

FIG. 3 illustrates a histogram plot of quantities of parts/assemblies vs. percent runtimes and the resulting number of years forecasted until return for rebuild as a function of the percent runtimes.

FIG. 4 is a flow chart illustrating logic for forecasting core return for remanufacturing.

### DETAILED DESCRIPTION

A system for forecasting core return for remanufacturing according to various embodiments of this disclosure uses historical machine data to provide an accurate forecast of when core machine parts and assemblies will be returned for remanufacture or rebuild. An exemplary embodiment of the system includes a central processing unit (CPU) for executing machine instructions and a memory for storing machine instructions to be executed by the CPU. The machine instructions implement various operations when executed by the CPU that include receiving at the CPU historical machine data including warranty claims for units of a particular core machine part or assembly. The stored machine instructions also cause the CPU to determine from the historical machine data at least one of specific service and failure intervals for the units of the particular core machine part or assembly. The stored machine instructions still further cause the CPU to determine an actual percent runtime of the units of the particular core machine part or assembly in the field, and the actual percent runtime is based on actual working hours for each unit of the particular core machine part or assembly divided by total hours in service for each unit from release to the most recent repair date.

The CPU is configured to forecast a length of time until a sufficient number of the units of the particular core machine part or assembly needing remanufacturing will be returned to a business manufacturing facility to meet a minimum threshold quantity of good core predetermined to meet a business justification for setting up a remanufacturing operation for returned core. In various implementations of this disclosure, the predetermined minimum threshold quantity may be a sufficient quantity of units of the core machine part or assemblies that have been returned for remanufacture to economically justify the expense of assigning human resources and capital equipment to the remanufacturing process. In some implementations, remanufacturing or rebuild processes may require significant capital expenditures and allocation of both physical and human resources. Therefore, the predetermined minimum threshold quantity of core may be a quantity of returned core that will result in sufficient savings or profit after the returned core is remanufactured or rebuilt to justify the expenditures. Upon determining a forecasted date when the predetermined minimum threshold quantity of good core will be returned, the CPU may also be configured to output one or more action items to one or more relevant business units based on the forecasted date. The action items may include at least one of acquiring capital for a remanufacturing operation, setting up a remanufacturing line, and assigning human resources for the remanufacturing line.

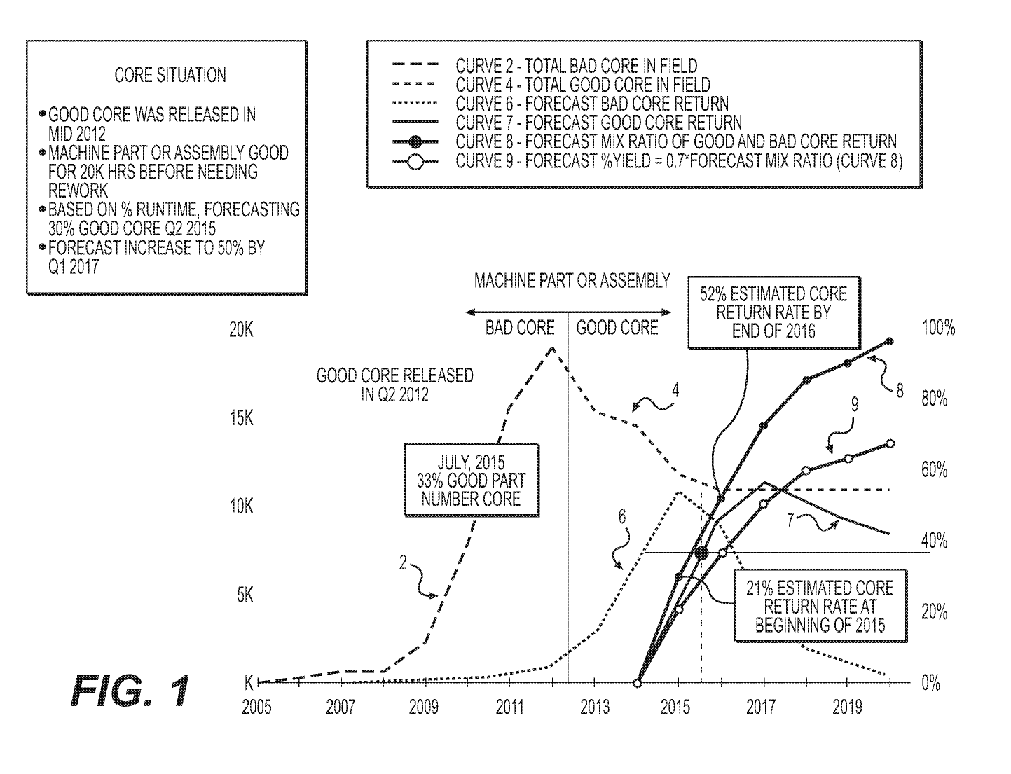

As shown in FIG. 1, the CPU may be configured to plot the quantity of core released to the field over time, and the dates by which forecasted quantities of core are returned from the field for remanufacturing. A system according to various embodiments of this disclosure may include one or more memories storing machine instructions to be executed by the CPU. The machine instructions implement a number of different operations when executed by the CPU. As plotted in FIG. 1, the CPU may be configured to determine a total number of units of the particular core machine part or assembly placed in service in the field, and dates when each of the units of the particular core machine part or assembly was placed in service in the field. The CPU may also be configured to receive a cut-off date before which the core is identified as bad core as a result of a design change rendering the core released before the cut-off date unuseable and the core released after the cut-off date good useable core. In the exemplary embodiment of FIG. 1, the cut-off date indicative of when such a design change occurred is around mid-2012. Curve 2 plots the quantities of the core being released into the field from 2005 up until the cut-off date at mid-2012. Because all core released into the field before mid-2012 did not include the design update implemented mid-2012, curve 2 is a plot of the quantities of bad core released out in the field.

After the design update in mid-2012, the number of units of additional core machine parts and assemblies released into the field are plotted along curve 4 (good core). The system further includes machine instructions stored in the memory and implemented by the CPU that may cause the CPU to receive historical machine data including warranty claims for one particular model number or serial number for the units of the core machine part or assembly. In alternative embodiments, the machine instructions implemented by the CPU may cause the CPU to receive historical machine data including warranty claims for one of a plurality of different model numbers or serial numbers of the core machine part or assembly that all have related operational characteristics. The historical machine data received by the CPU may include at least one of specific service and failure intervals for the units of the particular core machine part or assembly. In addition to warranty claims, the CPU may also be configured to receive indications of non-warranty service or repairs, as well as recommended service intervals or overhaul periods.

The specific service and failure intervals for units of the core machine part or assembly may be indicative of a potential need for remanufacturing or rebuild of the particular core machine part or assembly. In some cases remanufacturing to bring the part or assembly back into like-new condition may include operations such as weld build-up of worn areas, inspection and weld repair of defects such as cracks and other anomalies, various machining operations such as grinding, laser cutting, and polishing worn surfaces, various heat treatment procedures, and replacement of worn parts with new or refurbished parts. The CPU may be configured to determine an expected length of time in service before a particular core machine part or assembly will typically need to be returned for rebuild or remanufacturing. The expected length of time in service before a forecasted return for remanufacturing may be correlated by the CPU to the percent runtime for each unit of the particular core machine part or assembly. As discussed above, the actual percent runtime for each unit of core is based on actual working hours for each unit of the particular core machine part or assembly divided by total hours in the field for each unit from release to the most recent repair date (% runtime=actual working hours in service/[(repair date−in service date)*24]).

In the exemplary embodiment illustrated in FIG. 1, the design change occurring at the cut-off date in mid-2012 may be the result of a business decision such as continuous product improvement (CPI) or new product introduction (NPI) to change a characteristic of the particular core machine part or assembly. Core released into the field before the cut-off date in mid-2012 is classified as bad core if the modification in a part or assembly characteristic that occurs as a result of the design change at the cut-off date cannot be accomplished within acceptable business parameters by a remanufacturing operation. An example of a design change that may result in a core machine part or assembly already released to the field no longer being of use for remanufacturing is a change resulting in the addition of material to a part. Unless the part that has now been designed to include additional material lends itself to an additive manufacturing process, such as 3D printing, and the additive manufacturing process is economically viable, the core released before the design update may have to be scrapped. Other examples of design changes that may result in core machine parts or assemblies being classified as bad core include changes in the required materials for the part or assembly, changes in the properties or heat treatment of materials, and changes to configurations of parts that cannot be achieved on existing core in a cost effective manner.

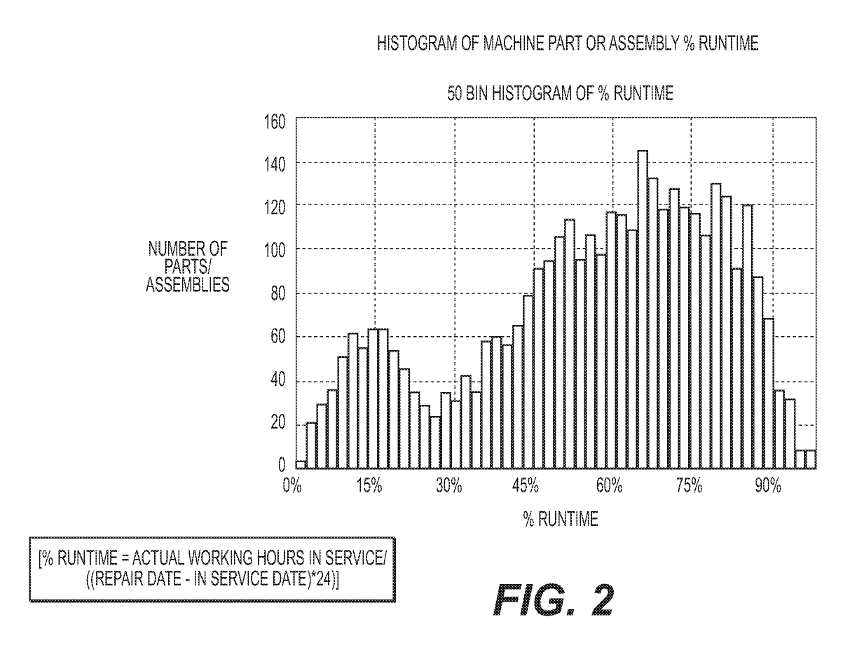

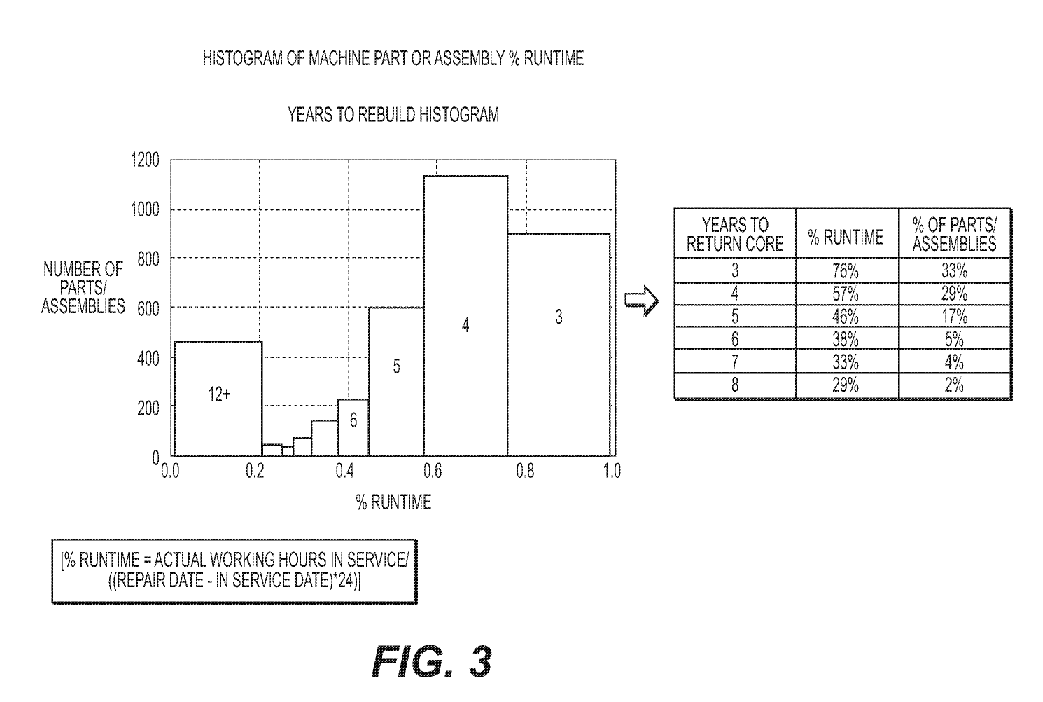

Various exemplary embodiments of the system according to this disclosure may be configured with one or more memories that further include additional machine instructions, which when implemented by the CPU cause the CPU to forecast a length of time until a sufficient number of the units of the particular core machine part or assembly needing remanufacturing will be returned to a business manufacturing facility to meet a minimum threshold quantity of core. The minimum threshold quantity of core may be predetermined as a quantity of returned core that will meet a business justification for setting up a remanufacturing operation for the returned core. In the graph of FIG. 1, bad core released to the field before the cut-off date in mid-2012 (plotted along curve 2), is forecasted to begin returning in need of rebuild or remanufacturing as plotted along curve 6. Good core released to the field after the cut-off date in mid-2012 (plotted along curve 4), is forecasted to begin returning in need of rebuild or remanufacturing as plotted along curve 7. FIGS. 2 and 3 illustrate one exemplary implementation of a process by which the CPU may be further configured to perform the forecasting.

As shown in FIG. 2, the system according to this disclosure may be configured with one or more memories that further include additional machine instructions, which when implemented by the CPU cause the CPU to determine the total numbers of units of the particular core machine part or assembly that are associated with each of a plurality of predetermined bins or intervals representing ranges of percent runtimes of the units. In the exemplary histogram generated by the CPU and illustrated in the chart of FIG. 2, values for percent runtime (% runtime) are divided into 50 bins or intervals, with each bin representing a 2% range of percent runtimes. For example, the 1st bin in the histogram of FIG. 2 represents 0%-2% runtime, the 2nd bin represents 2%-4% runtime, the 3rd bin represents 4%-6% runtime . . . and the 50th bin represents 98%-100% runtime. Each bar of the histogram also represents the total number of core machine parts or assemblies that fall within the range of percent runtimes for that bar. The histogram method of plotting the relationship between percent runtimes of parts or assemblies and the actual number of parts or assemblies in the field that fall within each of the actual ranges of percent runtimes enables the CPU to determine trends in how particular parts or assemblies are actually being used in the field. Although the example in FIG. 2 uses bins that each represent a 2% range of percent runtimes, one of ordinary skill in the art will recognize that other implementations may use different bin widths, with each bin representing a larger or smaller range of percent runtimes for units of the core machine parts or assemblies. If the bin width is selected too small, it may show too much individual data, and therefore not allow the CPU to readily identify an underlying pattern or frequency distribution of the data. Similarly, if the bin width is selected too large, the histogram may not be helpful to the CPU in identifying an underlying pattern or frequency distribution of the data. Some parts and assemblies, such as those that are included on heavy mining machinery, may experience percent runtimes that approach 100%, since the economics of the mining industry may demand that the machines work around the clock, 24 hours a day, every day of the year. In other applications, such as for parts or assemblies on an intermittently used portable power generating genset, the percent runtimes may be much lower. The histogram method utilized by the CPU may be particularly useful when an embodiment of the system according to this disclosure involves a number of different use applications for one or more models or serial numbers of the core machine parts or assemblies that end up in the field. In situations where a forecasted core return rate is needed for a part or assembly that is applied consistently in the same application with a known percent runtime, the CPU may not need to utilize a histogram method of categorizing parts or assemblies according to percent runtimes in order to identify underlying patterns or frequency distribution of the data.

In the particular application illustrated in the graph of FIG. 1, curve 8 illustrates a forecasted mix of both good core and bad core expected to be returned for rebuild or remanufacture. The curve 8 may be determined by the CPU after combining results from both the curve 6 of forecasted bad core return and curve 7 of forecasted good core return, with various weightings being assigned to each of the forecast core return curves if desired. The forecasts of when various percentages of the total number of units of core machine parts or assemblies out in the field will be returned for rebuild or remanufacturing may be based on an analysis of percent runtimes for particular units and historical machine data associated with the units including warranty claims. The dates illustrated along the abscissa of the graph in FIG. 1 may be derived by the CPU from an analysis of the relationships between percent runtimes for various percentages of the total number of units of core in the field and the number of years until those units are returned for rebuild or remanufacture. The histogram plot of years to rebuild included in FIG. 3 illustrates a determination by the CPU of a plurality of estimated time periods until various units of the particular core machine part or assembly will need remanufacturing, with each of the plurality of estimated time periods being associated with a range of actual percent runtimes for the units of the particular core machine part or assembly. The histogram of years to rebuild shown in FIG. 3 is correlated by the CPU with the table also illustrated to the right of the histogram in FIG. 3. As shown in the table of FIG. 3, the different percent runtimes for different percentages of the total number of units of core machine parts or assemblies out in the field are correlated with different numbers of years that are forecasted before those percentages of the units are returned for rebuild or remanufacture. For example, in the exemplary embodiment of FIG. 3, the CPU determines that 33% of the core parts or assemblies out in the field have a percent runtime of 76%, and are forecasted to be returned for rebuild or remanufacture in 3 years. 29% of the core parts or assemblies out in the field have a percent runtime of 57%, and are forecasted to be returned for rebuild or remanufacture in 4 years. Accordingly, various exemplary embodiments of the system according to this disclosure may be configured with one or more memories that further include additional machine instructions, which when implemented by the CPU cause the CPU to forecast the estimated core return rates plotted along curve 8 in FIG. 1 using the data derived from the histogram and associated table illustrated in FIG. 3. The machine instructions may also cause the CPU to forecast percent yields of good core returned for remanufacture from the forecast mix ratio of good and bad core plotted along curve 8 in FIG. 1 by estimating a 70% yield rate and plotting those results along the curve 9 in FIG. 1.

Various exemplary embodiments of the system according to this disclosure include one or more memories configured to store additional machine instructions, which when implemented by the CPU cause the CPU to output one or more action items to one or more relevant business units based on the forecasted lengths of time until the forecasted percent yields of good core have been returned. The action items output by the CPU based on the forecasted core return rates may include at least one of acquiring capital for a remanufacturing operation, setting up a remanufacturing line, and assigning human resources for operation of the remanufacturing line. One of ordinary skill in the art will recognize that accurate forecasts of when to expect certain quantities of returned good core will assist in making informed business judgments regarding the amount of resources, types of resources, and allocation of resources that will provide the best return on investment and will meet or exceed customer expectations for a particular business producing the core machine parts and assemblies.

An exemplary implementation of a method performed by a CPU configured according to this disclosure will be discussed in the following section.

### INDUSTRIAL APPLICABILITY

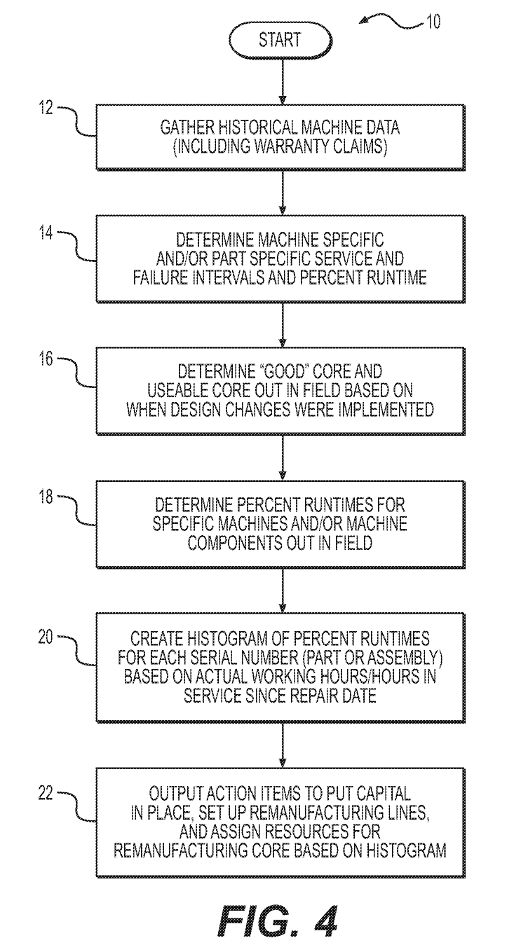

FIG. 4 is a flowchart of one exemplary implementation of a method that may be performed by one or more central processing units and memories included in a system according to embodiments of this disclosure. The disclosed method addresses core availability and quality issues, and enables the forecasting of when sufficient good core will be returned to meet a predetermined minimum threshold that will facilitate the achievement of many business objectives. Business objectives realized by the system and methods of the present disclosure for forecasting core return for remanufacturing include keeping resources used throughout the manufacturing process within the business's value chain through a circular flow of materials, energy, and water, in addition to efficiently managing human resources. A focus on better systems for managing core will optimize the use of resources, maximize the total life cycle value of products, and minimize the cost of ownership of the products by customers. An effective core management program according to this disclosure contributes to a business objective of making sustainable progress for communities, the environment, and the economy. Remanufacturing and rebuild programs increase the lifespan of equipment by providing customers with product updates for a fraction of the cost of buying a new machine. Additional benefits to the customer include ensuring maximum productivity, increasing reliability and equipment runtime, ensuring cost-effective performance, receiving a like-new warranty, increasing customer return on investment, providing the customer with a variety of repair options, providing the customer with higher resale value, and preserving the majority of energy and materials required to make the original parts or assemblies of parts.

As shown in the exemplary implementation illustrated in the flowchart of FIG. 4, after the start 10 of the exemplary process, machine instructions implement various operations when executed by one or more CPU's of a system according to this disclosure. At Step 12, the one or more CPU's gather historical machine data, including warranty claims. At Step 14, a CPU determines machine specific and/or part specific service and failure intervals and percent runtime. As discussed above, percent runtimes for particular units of core machine parts and assemblies are calculated by the CPU as a function of the number of actual working hours the part or assembly is in service divided by the number of total hours the units of core machine parts and assemblies have been in the field between an initial in service date and a repair date (% runtime=actual working hours in service/((repair date−in service date)*24)).

At Step 16, the CPU determines good core and useable core out in the field based on when design changes were implemented. As discussed above, the CPU may be configured to receive a cut-off date before which the core is identified as bad core as a result of a design change rendering the core released before the cut-off date unuseable and the core released after the cut-off date good useable core. Core released into the field before the cut-off date is classified as bad core if the modification in a part or assembly characteristic that occurs as a result of the design change at the cut-off date cannot be accomplished within acceptable business parameters by a remanufacturing operation. An example of a design change that may result in a core machine part or assembly already released to the field no longer being of use for remanufacturing is a change resulting in the addition of material to a part.

At Step 18, the CPU determines percent runtimes for specific machines and/or machine components out in the field. As discussed above, percent runtimes are a function of the number of actual working hours the part or assembly is in service divided by the number of total hours the units of core machine parts and assemblies have been in the field between an initial in service date and a repair date. Some use applications will have high percent runtimes if the part or assembly is used in a machine that is operated throughout the day and nearly every day of the week, as with the heavy machinery used for mining operations. Other applications, such as for machines that are only used intermittently, will have significantly lower percent runtimes.

When a forecast of the amount of good core that will be returned by certain dates involves a large variety of different parts or assemblies that have a wide range of percent runtimes, Step 20 involves the CPU creating a histogram of percent runtimes for each serial number (part of assembly) based on actual working hours for the part divided by the total hours that particular part has been in service. A histogram of the number of years until percentages of the total parts or assemblies in the field having certain percent runtimes will be returned for rebuild or remanufacture may also be created by the CPU. The histogram of years to rebuild may assist with detecting trends and identifying relationships between the percentage of parts in the field with certain percent runtimes, and the length of time until those parts will be returned for rebuild or remanufacture. The results of determining these relationships may be applied by the CPU at Step 22 to output action items to various business units to put capital in place, set up remanufacturing lines, and assign resources for remanufacturing core based on the trends and relationships identified with the histograms.

It will be apparent to those having ordinary skill in the art that various modifications and variations can be made to the disclosed system for forecasting core return for remanufacturing without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A system for forecasting core return for remanufacturing, the system comprising:
a central processing unit (CPU) for executing machine instructions and a memory for storing machine instructions to be executed by the CPU, the machine instructions implementing the following operations when executed by the CPU:
receiving at the CPU historical machine data including warranty claims for units of a particular core machine part or assembly;
determining, using the CPU, from the historical machine data at least one of specific service and failure intervals for the units of the particular core machine part or assembly;
determining, using the CPU, an actual percent runtime of the units of the particular core machine part or assembly in the field, wherein the actual percent runtime is based on actual working hours for each unit of the particular core machine part or assembly divided by total hours in service for each unit from release to the most recent repair date;
forecasting, using the CPU, a length of time until a sufficient number of the units of the particular core machine part or assembly needing remanufacturing will be returned to a business manufacturing facility to meet a minimum threshold quantity of core predetermined to meet a business justification for setting up a remanufacturing operation for returned core; and
outputting one or more action items to one or more relevant business units based on the forecasted length of time having elapsed to at least one of acquire capital for a remanufacturing operation, set up a remanufacturing line, and assign human resources for the remanufacturing line.

2. The system of claim 1, wherein the memory includes further machine instructions to be executed by the CPU, the machine instructions implementing the following operations when executed by the CPU:
determining, using the CPU, a total number of units of the particular core machine part or assembly placed in service in the field, and dates when each of the units of the particular core machine part or assembly was placed in service in the field; and
determining, using the CPU, a cut-off date before which the core is identified as bad core as a result of a design change rendering the core released before the cut-off date unuseable and the core released after the cut-off date good useable core.

3. The system of claim 1, wherein the machine instructions stored in the memory and implemented by the CPU cause the CPU to receive historical machine data including warranty claims for one particular model number or serial number for the units of the core machine part or assembly.

4. The system of claim 1, wherein the machine instructions stored in the memory and implemented by the CPU cause the CPU to receive historical machine data including warranty claims for one of a plurality of different model numbers or serial numbers of the core machine part or assembly that all have related operational characteristics.

5. The system of claim 1, wherein the at least one of specific service and failure intervals for the units of the particular core machine part or assembly is indicative of a potential need for remanufacturing of the particular core machine part or assembly.

6. The system of claim 2, wherein the design change occurring at the cut-off date is the result of a business decision such as continuous product improvement (CPI) or new product introduction (NPI) to change a characteristic of the particular core machine part or assembly, and the change in the characteristic cannot be accomplished within business goals by a remanufacturing operation.

7. The system of claim 1, wherein the memory further includes additional machine instructions, which when implemented by the CPU cause the CPU to:
forecast a length of time until a sufficient number of the units of the particular core machine part or assembly needing remanufacturing will be returned to a business manufacturing facility to meet a minimum threshold quantity of core predetermined to meet a business justification for setting up a remanufacturing operation for returned core, wherein the CPU is further configured to perform the forecasting by:
determining total numbers of units of the particular core machine part or assembly that are associated with each of a plurality of predetermined bins or intervals representing ranges of percent runtimes of the units; and
determining a plurality of estimated time periods until the units of the particular core machine part or assembly will need remanufacturing, with each of the plurality of estimated time periods being associated with a range of actual percent runtimes for the units of the particular core machine part or assembly.

8. The system of claim 7, wherein the memory further includes additional machine instructions, which when implemented by the CPU cause the CPU to:
generate a 50 bin histogram relating a total number of units of the particular core machine part or assembly out in the field that are associated with each of a 2 percent range of actual percent runtimes of the units; and
generate another histogram relating a total number of units of the particular core machine part or assembly out in the field that are associated with each of a number of years forecasted until the particular units of the core machine part or assembly require remanufacturing.

9. The system of claim 7, wherein the memory further includes additional machine instructions, which when implemented by the CPU cause the CPU to:
determine a total quantity of units of the particular core machine part or assembly placed in service in the field, and the dates when the units of the particular core machine part or assembly were placed in service in the field;
determine a cut-off date before which the core is identified as bad core as a result of a design change rendering the core released before the cut-off date unuseable and the core released after the cut-off date good useable core; and
determine a relationship between percentages of a mix of bad core out in the field and good core out in the field and dates by which the percentages of the mix are expected to be returned for remanufacturing.

10. A method for forecasting core return for remanufacturing, the method comprising:
receiving, at a CPU, historical machine data including warranty claims for units of a particular core machine part or assembly;
determining, using the CPU, at least one of specific service and failure intervals for the units of the particular core machine part or assembly;
determining, using the CPU, an actual percent runtime of the units of the particular core machine part or assembly in the field, wherein the actual percent runtime is based on actual working hours for each unit of the particular core machine part or assembly divided by total hours in service for each unit from release to the most recent repair date;
forecasting, using the CPU, a length of time until a sufficient number of the units of the particular core machine part or assembly needing remanufacturing will be returned to meet a minimum threshold quantity of core predetermined to meet a business justification for setting up a remanufacturing operation for returned core; and
outputting one or more action items to one or more relevant business units based on the forecasted length of time having elapsed to at least one of acquire capital for a remanufacturing operation, set up a remanufacturing line, and assign human resources for the remanufacturing line.

11. The method of claim 10, further including:
determining, using the CPU, a total number of units of the particular core machine part or assembly placed in service in the field, and dates when each of the units of the particular core machine part or assembly was placed in service in the field; and
determining, using the CPU, a cut-off date before which the core is identified as bad core as a result of a design change rendering the core released before the cut-off date unuseable and the core released after the cut-off date good useable core.

12. The method of claim 10, further including receiving, at the CPU, historical machine data including warranty claims for one particular model number or serial number for the units of the core machine part or assembly.

13. The method of claim 10, further including receiving, at the CPU, historical machine data including warranty claims for one of a plurality of different model numbers or serial numbers of the core machine part or assembly that all have related operational characteristics.

14. The method of claim 10, determining, using the CPU, at least one of specific service and failure intervals for the units of the particular core machine part or assembly that are indicative of a potential need for remanufacturing of the particular core machine part or assembly.

15. The method of claim 11, wherein the design change occurring at the cut-off date is the result of a business decision such as continuous product improvement (CPI) or new product introduction (NPI) to change a characteristic of the particular core machine part or assembly, and the change in the characteristic cannot be accomplished within acceptable business parameters by a remanufacturing operation.

16. The method of claim 1, further including:
forecasting a length of time until a sufficient number of the units of the particular core machine part or assembly needing remanufacturing will be returned to a business manufacturing facility to meet a minimum threshold quantity of core predetermined to meet a business justification for setting up a remanufacturing operation for returned core, wherein the forecasting includes:
determining total numbers of units of the particular core machine part or assembly that are associated with each of a plurality of predetermined bins or intervals representing ranges of percent runtimes of the units; and
determining a plurality of estimated time periods until the units of the particular core machine part or assembly will need remanufacturing, with each of the plurality of estimated time periods being associated with a range of actual percent runtimes for the units of the particular core machine part or assembly.

17. The method of claim 16, further including:
generating a 50 bin histogram relating a total number of units of the particular core machine part or assembly out in the field that are associated with each of a 2 percent range of actual percent runtimes of the units; and
generate another histogram relating a total number of units of the particular core machine parts or assemblies out in the field that are associated with each of a number of years forecasted until the particular units of the core machine parts or assemblies require remanufacturing.

18. The method of claim 16, further including:
determining a total quantity of units of the particular core machine part or assembly placed in service in the field, and the dates when the units of the particular core machine part or assembly were placed in service in the field;
determining a cut-off date before which the core is identified as bad core as a result of a design change rendering the core released before the cut-off date unuseable and the core released after the cut-off date good useable core; and
determining a relationship between percentages of a mix of bad core out in the field and good core out in the field and dates by which the percentages of the mix are expected to be returned for remanufacturing.

19. A computer-readable medium having stored thereon machine instructions to be executed by a CPU, the machine instructions implementing operations for forecasting core return for remanufacturing when executed by the CPU, the operations comprising:
receiving, at the CPU, historical machine data including warranty claims for units of a particular core machine part or assembly;
determining, using the CPU, at least one of specific service and failure intervals for the units of the particular core machine part or assembly;
determining, using the CPU, an actual percent runtime of the units of the particular core machine part or assembly in the field, wherein the actual percent runtime is based on actual working hours for each unit of the particular core machine part or assembly divided by total hours in service for each unit from release to the most recent repair date;
forecasting, using the CPU, a length of time until a sufficient number of the units of the particular core machine part or assembly needing remanufacturing will be returned to a business remanufacturing facility to meet a minimum threshold quantity of core predetermined to meet a business justification for setting up a remanufacturing operation for returned core; and
outputting, from the CPU, one or more action items to one or more relevant business units based on the forecasted length of time having elapsed to at least one of acquire capital for a remanufacturing operation, set up a remanufacturing line, and assign human resources for the remanufacturing line.

20. The computer-readable medium of claim 19, wherein the operations further include:
determining, using the CPU, a total number of units of the particular core machine part or assembly placed in service in the field, and dates when each of the units of the particular core machine part or assembly was placed in service in the field; and
determining, using the CPU, a cut-off date before which the core is identified as bad core as a result of a design change rendering the core released before the cut-off date unuseable as a result of a change in a characteristic of the particular core machine part or assembly that cannot be accomplished within acceptable business parameters by a remanufacturing operation.
